(19) United States
(12) Patent Application Publication
(10) Pub. No.: US 2005/0231358 A1
(43) Pub. Date: Oct. 20, 2005

(54) Search engine for singles with (GPS) position data

(76) Inventor: Steven Leo Company, Deerfield Beach, FL (US)

Correspondence Address: STEVEN LEO COMPANY, 4371 SW 10TH PL. #101, DEERFIELD BEACH, FL, 33442, US

(21) Appl. No.: 10/827,015

(22) Filed: Apr. 19, 2004

(51) Int. Cl. G08B 1/08

(52) U.S. Cl. 340/539.13; 340/573.1; 707/10; 455/73

(57) ABSTRACT

The software is used with any mobil decive with GPS (global positioning satellite) the software is used to search for singles in reference of the their actual position and not their zip code or city.

### BACKGROUND OF THE INVENTION

To search for singles by using the GPS ( global positioning satellite ) in any mobile device with internet conections, so when you send a request to the server it will search in the area if their are any singles that match your request.

### SUMMARY OF THE INVENTION

According to the present invention the software in the mobile devices with GPS (global positioning satellite) and internet conections is a better way to search for singles in the area instead of a zip code or city, because it is more accurate, once you send a request to the server, the server will search all the files of each member to verify if they are in your area this way your request will be return with data of singles near you.

### DETAILED DESCRIPTION

The software is a search engine for singles with an extra data that is the actual position of the members, the actual position is done with a GPS global positioning satellite, all this data is file in the server.

The member has a mobile device with GPS and internet conection so the data can be actualize to the server files.

When a member sends a request, the data contains his actual position, radius in (yards or miles) and gap age he/she selected, this way the server will search in his files if any singles in the area selected matchs his requests.

Once the search is done the return of the request is done with the singles that match his requests,if their are not singles you can request again with a different radius, to enlarge the area.

This software is more accurate for searching singles near your actual position, than using a zip code or city where members live but maybe not be their at the time you sent your request to the server to search for singles.

1. An software that is useful for mobil devices that have GPS (global positioning satellite) and internet conection for search of singles.

2. An software according to claim 1, wherein the user sends a requests to the server with data that contains reference of their actual position GPS, radius selected in (yards or miles) and gap of age.

3. An software that is loaded in the server where all the data of each member is register including their actual position with use of GPS(global positioning satellite)

4. An software according to claim 3 wherein the return of the request is the data of singles in the area.
